(19) United States
(12) Patent Application Publication
(10) Pub. No.: US 2020/0040287 A1
(43) Pub. Date: Feb. 6, 2020

(54) WATER-SOLUBLE MICELLES FOR DELIVERY OF OIL-SOLUBLE MATERIALS

(71) Applicants: THE ADMINISTRATORS OF THE TULANE EDUCATIONAL FUND, New Orleans, LA (US); ENI S.p.A., Roma (IT)

(72) Inventors: Kyriakos PAPADOPOULOS, New Orleans, LA (US); Riccardo RAUSA, San Donato Milanese (MI) (IT)

(73) Assignees: THE ADMINISTRATORS OF THE TULANE EDUCATIONAL FUND, New Orleans, LA (US); ENI S.p.A., Roma (IT)

(21) Appl. No.: 16/339,075

(22) PCT Filed: Oct. 6, 2017
(86) PCT No.: PCT/US2017/055535

§ 371 Date: Apr. 3, 2019

Related U.S. Application Data
(60) Provisional application No. 62/405,028, filed on Oct. 6, 2016.

(51) Int. Cl. C11D 17/00; C09K 8/584; C09K 8/588; C11D 11/00; C11D 1/65; B08B 3/08; B09C 1/08

(52) U.S. Cl. CPC C11D 17/0021; C09K 8/584; C09K 8/588; C11D 1/58; C11D 1/652; B08B 3/08; B09C 1/08; C11D 11/0023

(57) ABSTRACT

A micellar compositions including oil-soluble surfactants delivered by water-soluble surfactants are disclosed. The micellar compositions demonstrate enhanced crude oil mobilization in porous media. When the porous media was imbued with crude oil, the presence of the surfactant in the oil phase improved the mobilization performance of crude oil. Solutions of SDS were used to solubilize the surfactant, and the formation of SDS/PIBSI micellar composition was confirmed by Cryo-SEM images. High cleaning effectiveness of the micellar compositions on crude oil entrapped in porous media was demonstrated by image binarization.

### CROSS-REFERENCES TO RELATED APPLICATIONS

The present application claims priority benefit of U.S. Provisional Application No. 62/405,028 filed on Oct. 6, 2016 wherein said application is incorporated herein by reference as set forth in full below.

### FIELD OF THE INVENTION

The present invention relates to novel micellar compositions for delivery of oil-soluble materials, including surfactants, and to methods of production and use of novel hydrophilic micellar carrier compositions for oil-soluble materials.

### DESCRIPTION OF RELATED ART

Enhanced oil recovery (EOR) is widely used to increase the amount of crude oil that may be extracted from an oil reservoir in the realm of oil production industry. There are many different methods of EOR, including thermal methods, gas injection, and chemical injection. According to the U.S. Department of Energy, only 20 percent to 40 percent of the crude oil in a particular reservoir may be extracted using traditional methods, but with the application of various methods of EOR, extraction of more than 60 percent may be obtained. Due to increased demand for crude oil and to the decline of new crude oil reservoir discoveries, the maximization of crude oil production in each reservoir is becoming progressively more critical.

Mobilization of crude oil within porous media is at the core of oil extraction and production processes. Additionally, it is a key phenomenon in oil spills when crude oil released in water reaches beach shores, as happened in the Deepwater Horizon oil spill in the Gulf of Mexico in 2010, one of the largest oil spills in the history of the petroleum industry. It is well documented that crude oil trapped in porous media such as sands, soils, and sediments can persist for several decades after an oil spill, in large part because the porous media-trapped oil cannot be easily weathered. However, smaller droplets of crude are easier to disperse with water flow and may be easily degraded by microbes. In order to break crude spilled in water into such smaller droplets, various surfactants are typically applied both in water and on land during the cleanup process.

Traditional surfactants used in both EOR and oil spill remediation are typically expensive and water soluble, leading to extremely high costs in oil spill remediation operations and high inefficiency for delivery of surfactant to the oil. There is thus a need for an inexpensive, oil-soluble surfactant that can mobilize crude oil entrapped in porous media. The present invention discloses such an oil-soluble surfactant that may be delivered to crude oil entrapped in porous media by means of water-soluble micelles.

The present disclosure provides compositions comprising an oil-soluble surfactant that is able to mobilize crude oil within porous media and a water-soluble surfactant able to form micelles in a water based fluid, that act as vehicles to deliver oil-soluble surfactant to an oily substance to be mobilized, such as crude oil in a subterranean formation. The oil-soluble surfactant contains a hydrophilic head and a hydrophobic tail of relatively high molecular weight, while the micellar carrier is hydrophilic and comprises a typical water-soluble surfactant, preferably inexpensive, and biodegradable.

While certain novel features of this invention shown and described below are pointed out in the annexed claims, the invention is not intended to be limited to the details specified, since a person of ordinary skill in the relevant art will understand that various omissions, modifications, substitutions and changes in the forms and details of the invention illustrated and in its operation may be made without departing in any way from the spirit of the present invention. No feature of the invention is critical or essential unless it is expressly stated as being “critical” or “essential.”

### BRIEF SUMMARY OF THE INVENTION

The present invention provides novel micellar compositions comprising oil-soluble materials in a water-soluble carrier.

The present invention also provides micellar compositions comprising materials with a hydrophilic head and hydrophobic tail in a hydrophilic carrier.

In accordance with this discovery, it is an object of the invention to provide a method of producing hydrophilic micellar carrier compositions for oil-soluble materials.

It is an additional object of this invention to provide novel dispersants.

It is an additional object of this invention to provide methods of improved enhanced oil recovery.

It is an additional object of this invention to provide methods of improved oil spill cleanup.

Other objects and advantages of this invention will become readily apparent from the ensuing description.

### BRIEF DESCRIPTION OF THE DRAWINGS

The following drawings form part of the present specification and are included to further demonstrate certain aspects of the present invention. The invention may be better understood by reference to one or more of these drawings in combination with the description of specific embodiments presented herein.

FIG. 1A shows drainage of a two-phase flow in a miniature packed bed.

FIG. 1B shows imbibition of a two-phase flow in a miniature packed bed.

FIG. 2 shows the “alder-ene” type synthesis of PIBSA (polyisobutenyl anhydrides).

FIG. 3 shows the general chemical structure of different PIB SA derivatives.

FIGS. 4A and 4B shows instant drainage flow patterns for water/crude, water/crude (1% Span 80 by weight), and water/crude (1% ES by weight) systems at 0.1 μL/min (FIG. 4A) and 1.0 μL/min (FIG. 4B).

FIG. 5 shows four microscopic images of a. clean cryolite; b. water/crude; c. water/crude (about 1% Span 80 by weight); and d. water/crude (about 1% ES by weight) systems after instant imbibition tests at about 1.0 μL/min

FIG. 6 shows an 8-bit intensity grayscale stepped pattern.

FIG. 7 shows four cropped microscopic images of a. clean cryolite; b. water/crude; c. water/crude (about 1% Span 80 by weight); and d. water/crude (about 1% ES by weight) systems after instant imbibition tests at about 1.0 μL/min.

FIG. 8 shows four histograms of cropped microscopic images of a. clean cryolite; b. water/crude; c. water/crude (about 1% Span 80 by weight); and d. water/crude (about 1% ES by weight) systems after instant imbibition tests at about 1.0 μL/min.

FIG. 9 shows four cropped binary microscopic images of a. clean cryolite; b. water/crude; c. water/crude (about 1% Span 80 by weight); and d. water/crude (about 1% ES by weight) systems after instant imbibition tests at about 1.0 μL/min.

FIGS. 10A and 10B shows 20× magnification pictures of two immediately-cleaned cryolite packed beds which were immersed with crude oil containing 1% Span 80 by weight (FIG. 10A) and crude oil containing 1% ES by weight (FIG. 10B).

FIG. 11 shows Cryo-SEM images for pure SDS aqueous solution at 0.4 M, at both low and high magnification.

FIG. 12 shows Cryo-SEM images for SDS:ES solutions in concentrations of a. 1000:1, b. 500:1, and c. 100:1, respectively. Each image includes both low and high magnification.

FIG. 13 shows schematics of oil mobilization through porous media. A. Oil (gray) shown in porous media (black) with water (white) present. B Oil-soluble dispersants shown as black line shells around the mobilized oil drops. C. The oil drops are shown to move freely through the porous medium without reattachment.

FIG. 14 shows a micelle with surfactant hydrophilic groups (circles) pointing outwards, and an inner core (lines) consisting of the hydrophobic moieties of surfactants and oil-soluble dispersants.

### DETAILED DESCRIPTION OF THE INVENTION

Detailed descriptions of one or more preferred embodiments are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in any appropriate manner.

Wherever any of the phrases “for example,” “such as,” “including” and the like are used herein, the phrase “and without limitation” is understood to follow unless explicitly stated otherwise. Similarly “an example,” “exemplary” and the like are understood to be non-limiting.

The term “substantially” allows for deviations from the descriptor that do not negatively impact the intended purpose. Descriptive terms are understood to be modified by the term “substantially” even if the word “substantially” is not explicitly recited. Therefore, for example, the phrase “wherein the lever extends vertically” means “wherein the lever extends substantially vertically” so long as a precise vertical arrangement is not necessary for the lever to perform its function.

The terms “comprising” and “including” and “having” and “involving” (and similarly “comprises”, “includes,” “has,” and “involves”) and the like are used interchangeably and have the same meaning. Specifically, each of the terms is defined consistent with the common United States patent law definition of “comprising” and is therefore interpreted to be an open term meaning “at least the following,” and is also interpreted not to exclude additional features, limitations, aspects, etc. Thus, for example, “a process involving steps a, b, and c” means that the process includes at least steps a, b and c. Wherever the terms “a” or “an” are used, “one or more” is understood, unless such interpretation is nonsensical in context.

The term “soluble” as used, for example, in terms “oil-soluble” and “water-soluble” with reference to the surfactants according to the present invention, means that the relevant surfactant can be dissolved at least partially, in mineral oil or water respectively. In particular, at least 1 g, preferably at least 5 g, of “oil-soluble” or “water-soluble” surfactant can be dissolved in 100 ml of mineral oil or water respectively. In this particular case “mineral oil” means a typical hydrocarbon mixture like crude oil. An oil-soluble surfactant is generally not soluble in water.

In one embodiment, the present invention provides novel micellar compositions to deliver oil-soluble materials to oil entrapped in porous media. In another embodiment, the present invention provides novel micellar compositions comprising oil-soluble materials in water-soluble carriers. In a preferred embodiment, the present invention provides a micellar composition comprising a material with a hydrophilic head and a hydrophobic tail in a hydrophilic carrier.

In one embodiment, the present invention may be a composition comprising a predetermined amount of at least one oil-soluble surfactant and a predetermined amount of at least one water-soluble surfactant.

The at least one oil-soluble surfactant contains a hydrophilic head and a hydrophobic tail of relatively high molecular weight. Preferably the hydrophobic tail is a possibly substituted branched aliphatic group having a number average molecular weight ranging from 500 to 6,000, more preferably from 1,000 to 4,000. In a preferred embodiment the hydrophobic tail is obtained by polymerization of alkylene monomeric units, as, for example, isobutene, 1-hexene, 1-octene, 2-methyl-1-hexene, 4-fluoro-1-butene or mixtures thereof. The hydrophilic head of the oil soluble surfactant of the present invention may be any polar hydrophilic group like, for example, a carboxylic ester of an alcohol having from 1 to 15 carbon atoms, or an amide or imide group of an amine or polyamine having from 1 to 15 carbon atoms, for example a long chain alky-substituted succinic imide of a poliakylenamine (PAM) having from 4 to 14 carbon atoms. In a particular embodiment, the oil soluble surfactant of the present composition may be a diester or a di-imide of a diol or a diamine respectively, with a long-chain, branched, aliphatic carboxylic acid or anhydride.

In a particularly preferred embodiment of the present invention, said oil-soluble surfactant is selected from one or more polyisobutenyl anhydride (PIBSA) derived surfactants such as esters, amides or imides. In the case of polyalkylenesuccinimides (PIBSI), depending on the ratio PIBSA/PAM, both mono- and di-succinimides structures can be obtained.

The at least one water-soluble surfactant may comprise any known hydrophilic surfactant, like the sodium, potassium or ammonium alkylsulfate or alkylphosphate, with the alkyl moiety preferably having from 8 to 18 carbon atoms, like, for example, sodium dodecyl sulfate. In some embodiments, the hydrophilic surfactant is in aqueous solution.

The predetermined amount of the at least one water-soluble surfactant is preferably comprised from the minimum critical micellar concentration and the saturation concentration, i.e., the highest concentration at which the water-soluble surfactant does not separate from the solution. Preferably the amount of water-soluble surfactant is comprised between 0.3 and 0.9 times the saturation concentration. In certain embodiments, the saturation concentration is calculated at the temperature of the subterranean formation or at an intermediate temperature between room temperature and the temperature of the formation. For example, for sodium dodecyl sulfate, the preferred concentration may be from about 1 gram to about 12 grams per 100 mL of solution in water.

The predetermined amount of the at least one oil-soluble surfactant is normally selected in order to have a weight ratio of oil-soluble surfactant to water-soluble surfactant of about 1:10 to about 1:10000, preferably from about 1:20 to about 1:2000. In some embodiments, the weight ratio may be selected from the group comprising about 1:100, about 1:500, and about 1:1000.

Preferably said water-soluble surfactant and said oil-soluble surfactant form micellar structures of the water-soluble surfactant containing the oil-soluble surfactant.

The composition of the present invention may be used in at least one application selected from the group comprising encapsulants, emulsifiers, dispersants, surfactants, detergents, surface modifiers, nanocomposite fillers, drug delivery and/or catalysis, biomedical applications, research applications, consumer applications, industrial applications, or any other appropriate applications.

In another embodiment, the invention provides a method for removing one or more non-polar contaminants or substance from porous media comprising providing a composition comprising a predetermined amount of at least one oil-soluble surfactant as previously defined and a predetermined amount of at least one water-soluble surfactant as previously defined and applying said composition to at least one porous medium containing one or more non-polar contaminants. The method may further comprise wetting the at least one porous medium containing one or more non-polar substances or contaminants before applying the composition. The method may further comprise flushing, preferably with water or a water-based fluid, the at least one porous medium containing one or more non-polar substance or contaminants after applying the composition.

The composition used in the method may further comprise a predetermined amount of at least one solubilizing compound wherein said water-soluble surfactant and said oil-soluble surfactant are dissolved or dispersed, preferably forming micellar structures of the water-soluble surfactant containing the oil-soluble surfactant. In a preferred embodiment, said solubilizing compound is a hydrophilic carrier of the composition.

The at least one oil-soluble surfactant may comprise one or more polyisobutenyl anhydride derived surfactants such as esters, amides or imides as previously described. The at least one water-soluble surfactant may comprise sodium dodecyl sulfate. The at least one solubilizing compound may comprise water or a water-based fluid like salt water or reinjection water.

The predetermined amount of the at least one water-soluble surfactant is preferably comprised from the minimum critical micellar concentration and the saturation concentration, i.e., the highest concentration at which the water-soluble surfactant does not separate from the solution. Preferably the amount of water-soluble surfactant is comprised between 0.3 and 0.9 times the saturation concentration. In certain embodiments, the saturation concentration is calculated at the temperature of the subterranean formation or at an intermediate temperature between room temperature and the temperature of the formation. For example, for sodium dodecyl sulfate, the preferred concentration may be from about 1 gram to about 12 grams per 100 mL of solution in water.

The predetermined amount of the at least one oil-soluble surfactant is normally selected in order to have a weight ratio of oil-soluble surfactant to water-soluble surfactant of about 1:10 to about 1:10000, preferably from about 1:20 to about 1:2000. In some embodiments, the weight ratio may be selected from the group comprising about 1:100, about 1:500, and about 1:1000.

The one or more non-polar contaminants may be selected from the group comprising petroleum, toxins, pharmaceutical compositions, catalysts, or any other appropriate non-polar contaminants. The at least one porous medium may be selected from the group comprising sand, water-body sediment, soil, wood, rock, or any other appropriate porous medium.

In another embodiment, the present invention is a method for extracting oil from porous media comprising providing a composition as previously defined, comprising a predetermined amount of at least one oil-soluble surfactant and a predetermined amount of at least one water-soluble surfactant; applying said composition to one or more porous media, preferably by injection and contact with the porous media; and capturing any resulting oil from said one or more porous media, preferably according to the usual methods of oil-extraction and oil displacement. The method may be used in enhanced oil recovery procedures. The method may further comprise wetting the one or more porous media before applying the composition. The method may further comprise flushing the one or more porous media after applying the composition.

The one or more porous media may be selected from the group comprising oil shale, porous rock formations, sand, water-body sediment, soil, wood, rock, or any other appropriate porous medium.

In some embodiments, the present invention discloses micellar compositions with broad applications as oil spill dispersants or, more generally, for flushing one or more non-polar contaminants from porous media. The one or more non-polar contaminants or substance may be selected from the group comprising petroleum, toxins, pharmaceutical compositions, catalysts, or any other non-polar contaminant. In a preferred embodiment the non-polar substance is petroleum or mineral oil. In some embodiments, any of the micellar compositions disclosed herein may be used as encapsulants, emulsifiers, dispersants, surfactants, detergents, surface modifiers, nanocomposite fillers, drug delivery and/or catalysis, or for any other biomedical, research, consumer, or industrial applications.

Optical micro-capillary video-microscopy was used to microscopically visualize the two-phase, pressure-driven flow in an environment that mimics a natural porous medium. An oil phase invaded a porous network formed by packed, water-wetted cryolite grains; here, the two phases were the aqueous (surfactant) phase and the crude-oil phase. This video-microscopic setup uniquely enabled observations of the crude oil's mobilization on a microscopic scale and shows how an oil phase penetrates porous media as it displaces an aqueous phase and how an aqueous phase can clean up crude-oil-contaminated porous media when surfactant is introduced.

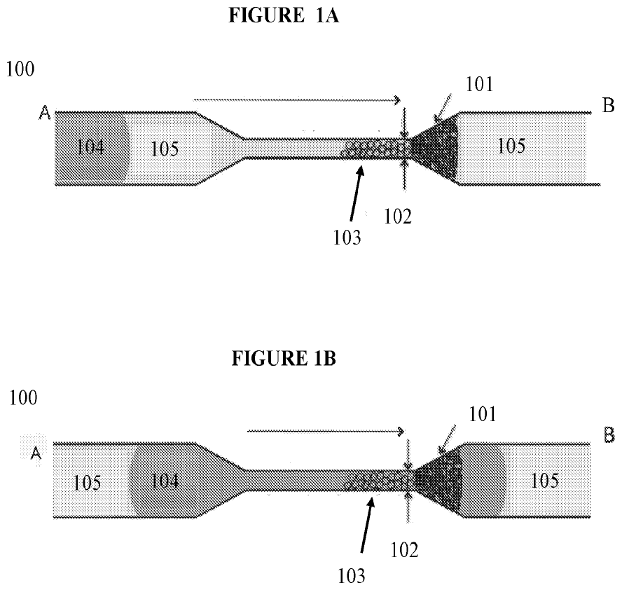

Generally, two types of displacements describe the two-phase flow in porous media: drainage and imbibition. Drainage is a phenomenon where a wetting phase is displaced by a non-wetting phase; the reverse process is termed imbibition. The schematics in FIGS. 1A and 1B show a cylindrical packed bed within a micro-capillary 100, which is packed with a randomly-arranged transparent natural mineral, cryolite 103. FIG. 1A shows drainage and FIG. 1B shows imbibition. In FIGS. 1A and 1B, the two-phase flow moves in the direction from end A to end B. Such a scheme simulates the two-phase flow in a heterogeneous soil environment. Because the cryolite packing 103 is water wetting, the aqueous phase is the wetting phase. The results detailed herein demonstrate successful delivery of oil-soluble surfactant to crude oil in cryolite packing via an SDS-stabilized micellar composition that acted as the flooding mixture in imbibition.

### EXAMPLES

Materials

Microcapillaries (1.5 m-1.8 mm O.D. 100 mm length, Corning) were purchased from Fisher Scientific. Deionized water generated from a Barnstead E-pure purifier (Thermo Scientific, Asheville, N.C.) was used. Cryolite (Synthetic, ≥97.0%), Sodium dodecyl sulfate (SD S) (ACS reagent ≥99.0%) and Span 80 were purchased from Sigma-Aldrich (St. Louis, Mo.). Crude oil from the Gulf of Mexico Deepwater-Horizon oil spill was provided by the Gulf of Mexico Research Initiative (GoMRI).

Oil-Soluble Surfactants

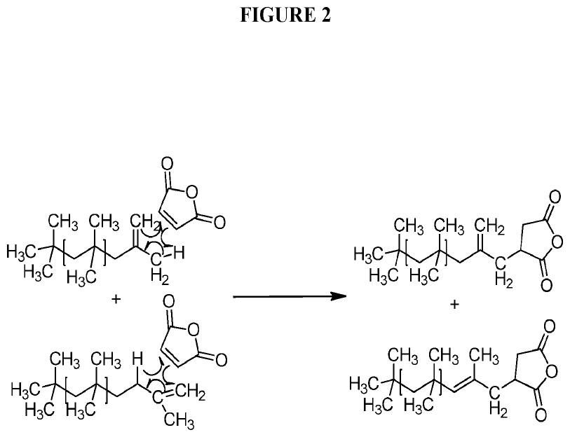

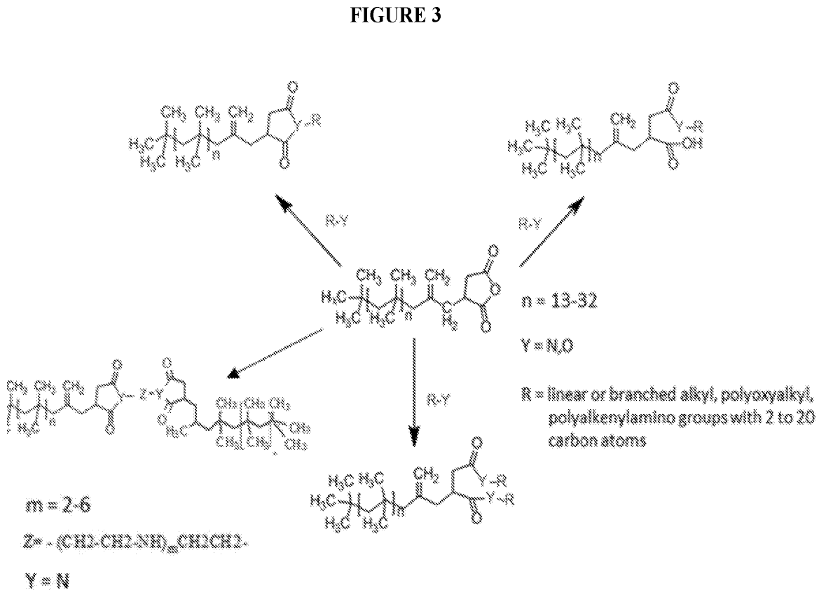

Examples of oil-soluble surfactants of the present invention were synthetized as described herein. However, we predict that any oil-soluble surfactants known in the art could be used. FIG. 2 shows the synthesis (150-200° C., 21 hrs) of polyisobutenyl anhydrides (PIBSA) as “alder-ene” type, in which the maleic anhydride (MA) behaves like an enophile to the reactive site of the polyisobutene (PIB) and, following an electronic rearrangement, leads to the addition of the anhydride on the polymeric backbone. By reacting PIBSA with different components such as amines, polyalkylene amines, alcohols etc. various other derivatives can be obtained (e.g., polyisobutenyl succinimides or PIBSI, Polyisobutenyl esters, PIBSE etc.), which are capable of interacting with the functional groups of organic species with their polar head and changing their properties in solution. Many structures can be obtained by tuning the chemical group added to the PIBSA molecule, and a general example of these structures is shown in FIG. 3.

Synthesis of the Oil-Soluble Surfactants

### Preparative Example: Synthesis of Polyisobutenyl Succinanhydride (PIBSA)

100 g of polyisobutene (Glissopal 1,000, BASF; Mn 1,000) are introduced into a 250 mL cylindrical glass reactor, equipped with a mechanical stirrer and a reflux condenser.

The reactor is heated, while flushing with nitrogen under stirring, until a temperature of 110° C. is reached. After 30 minutes, 14.7 g of maleic anhydride (MA) are added, under nitrogen. The mixture is heated to 200° C. and the reaction is kept under stirring for about 20 hours.

The temperature is then lowered to 160° C. and the unreacted MA is stripped under vacuum (0.2 mm Hg). Then the weight conversion degree of the reaction was evaluated, by difference, by quantifying the weight of unreacted polyisobutylene after its separation from the reaction mixture.

A weighed quantity of polyisobutenyl succinanhydride (PIBSA), dissolved in n-heptane, is eluted through a chromatographic column, containing silica gel. The eluted phase, containing only unreacted PIB, is then evaporated, dried under vacuum (0.2 mm Hg) and weighed.

The difference between the starting sample and the recovered PIB is due to PIBSA (yield 82% w/w). Total acid number 61.61 mg KOH/g (ASTM D664).

The functionalization degree (FD) expressed as grafted moles of succinic anhydride per mole of reacted polymer, was determined according to the procedure described in U.S. Pat. No. 4,952,328, after determining the acidity of the PIBSA, by titration according to what is described in the method ASTM D 664. In this case FD was 1.56.

### Example 1: Synthesis of Mono-Polyisobutenyl Succinimide with Polyalkylamine TETA (ES-1)

One example of an oil-soluble surfactant, mono polyisobutenyl succinimide (ES-1) is prepared by introducing 100 g of raw polyisobutenyl succinanhydride (PIBSA) as obtained in the previous example (including the unreacted PIB), into a jacketed cylindrical glass reactor, equipped with a mechanical stirrer, a lower drainage valve and a reflux condenser. 16.30 g of triethylene tetra-amine (TETA) are then added at a temperature of 130° C., under a nitrogen blanket, the temperature is brought to 165° C. and the reaction is continued for about two hours until complete conversion of PIBSA. The water formed is stripped away by applying, for an hour, a nitrogen flow.

### Example 2: Synthesis of Polyisobutenyl Bis-Succinimide with TETA (ES-2)

Another example of an oil-soluble surfactant, polyisobutenyl bis-succinimide (ES-2) was obtained, starting from PIBSA as obtained in the Preparative Example and following the same procedure as in Example 1 except for using 8.10 g of polyalkyl amine TETA per 100 g of PIBSA.

### Example 3: Synthesis of Polyisobutenyl Mono-Succinimide with PEHA (ES-3)

Yet another example of an oil-soluble surfactant, polyisobutenyl mono-succinimide (ES-3) was synthesized as shown in Example 1 starting from 10.0 g of PIBSA and adding 16.06 g of pentaethylenehexamine (PEHA) for 2 hours to bring the reaction to completion. The final product (ES-3) was isolated after stripping the reaction water by nitrogen flow.

Synthesis of Micelles Composition

To create the micelle composition, an oil-soluble surfactant is solubilized by a water-soluble surfactant. For example, an about 0.4 M of the water-soluble surfactant, SDS aqueous solution, is prepared, and then oil-soluble surfactant is added into the SDS solution and solubilized. In this example, SDS is used as the water-soluble surfactant, but we predict that any water-soluble surfactant known in the art could be used. For example, we predict that any of the following water soluble-surfactants may be used: Glucopon 2151, Glucopon 6501, Glucopon 6001, Resol 302, FINDET 1214N/23(Polyoxyethylene(11) alkyl(C12-14) ethers)3, FINDET 10/18 (Polyoxyethylene(6) alkyl(C8-12) ethers)3, RHEODOL MS-165V (GLYCERYL STEARATE, PEG-100 STEARATE)4, EMANON 11125 (PEG-12 LAURATE), EMASOL L-120V (Polyoxyethylene sorbitan monolaurate)6, Tween 80, Sodium Lauryl Sulfate, or Dioctyl sulfosuccinate sodium (AOT).

In this example, the SDS aqueous solution is created by adding the SDS to a solubilizing solution, such as water. Magnetic stirring with heating at about 50° C. was used during the solubilization. Micelles were prepared at various weight ratios of SDS/ES-1 as shown in Table 1.

### Example 4: Micelle Compositions and Tests

In order to prepare the SDS/ES-1 micelle mixture at weight ratio 100:1, the following steps are taken. First, 2.3069 g of SDS is weighed and dissolved in deionized water, up to 20 ml. Next, 0.0237 g of ES-1 is mixed into the 20 ml solution of SDS. The resulting mixture is magnetically stirred with heating at about 50° C. and micelles were formed. The micelles dissolve the ES-1, resulting in a clear mixture. The SDS/ES-1 micelle mixtures at weight ratios of 1000:1 and 500:1 are prepared in the same manner as the 100:1 micelle mixture except that the weight of ES-1 alone is varied. For the 1000:1 and 500:1 micelle mixtures, 0.0024 g and 0.0047 g of ES-1 are used, respectively.

The formation of SDS/ES-1 micelles was confirmed by cryogenic scanning electron microscopy (Cryo-SEM) imaging via a Hitachi S-4800 field emission scanning electron microscope. The samples were placed on a vacuum-transfer device and frozen by being plunged into liquid nitrogen. The frozen samples were fractured by a diamond knife and sublimated for about 5 minutes to remove surface water and to increase topographical contrast. The sample surface was sputtered with platinum-palladium alloy and then transferred to the chamber for imaging.

TABLE 1
List of SDS/ES-1 micellar solutions
prepared at various weight ratios

| SDS-only Solution | 0.4M |
|---|---|
| SDS:ES-1 | 1000:1 |
| SDS:ES-1 | 500:1 |
| SDS:ES-1 | 100:1 |

### Experimental Setup

Displacement experiments were conducted at room temperature under three different conditions, detailed below.

### Drainage

The microcapillary 100 was filled with water 105 and cryolite 103 as shown in FIG. 1A. Crude oil 104 was injected via syringe from the left side (end A) of the capillary and a pre-set flow rate was applied to push the crude oil 104 through the water pre-wetted cryolite packed bed (towards end B). A fixed section of packed bed was observed and recorded by a high-frame-rate digital camera (Imperx IPX-VGA-210-L) via XCAP™ Image Processing Software. The maximum captured length of cryolite packing 103 was about 1530 μm. The drainage process comprised the advancement of the oil phase 104 from the left end (end A) of the viewing field to the right end (end B).

### Instant Imbibition

When injected crude oil passes through the entrance of the packed bed, the water behind the oil becomes the new invading phase and cleans up the previously oil-contaminated packed bed. This process is called imbibition. When the imbibition of aqueous phase occurs immediately after the crude oil drainage process, the term “instant imbibition” is used. How the aqueous phase cleans the cryolite is compared and studied for different systems at this condition.

### Delayed Imbibition

Instead of flushing the crude oil from the cryolite immediately after drainage, the oil was left in the cryolite-packed bed for five days as delayed imbibition. This methodology takes into account the possibility that crude oil may increase the wettability of cryolite over time, which increases the difficulty of cleaning up the oil. It should be noted that “delayed drainage” does not exist, because prior to the invasion of crude oil into the aqueous phase, the cryolite was stored in water.

In each experimental condition discussed herein, the aqueous phase is deionized water, while the oil phases are original crude (control), a solution of oil-soluble ES-1/crude oil at about 1% by weight, and a solution of Span 80/crude oil at about 1% by weight, respectively. To begin the procedure for microcapillary packed bed preparation, the microcapillary 100 is pulled in the middle part with a microcapillary puller (Narishige PB-7, Japan) to approximately 150 μm in outer diameter 102 and to a length of approximately 1.4 cm in the pulled section. Next, a small piece of filter paper 101 is inserted from the right side (end B) as shown in FIGS. 1A and 1B, in order to prevent the cryolite particles 103 from flowing away. The entire microcapillary 100 is then filled with water 105 without any air bubbles remaining inside.

An amount of cryolite 103 is pre-wetted with water and then introduced into the pulled section of the microcapillary from the left side (end A) and packed into the pulled section. Crude oil or a crude oil solution containing 1% surfactant by weight 104 is injected from the left side (end A) by a 1 mL BD disposable syringe. The left end (end A) of the microcapillary 100 is connected to a syringe pump (Harvard Apparatus Picoplus), which can control the flow rate at the accuracy of 0.01 μL/min. To start the experiment, the pump pushes the entirety of the crude oil 104 into the cryolite section 103. Video recording begins when the crude oil 104 is about to enter the observed section and stops when the front of the oil 104 reaches the far end of the screen.

### Results and Discussion

### Instant Drainage

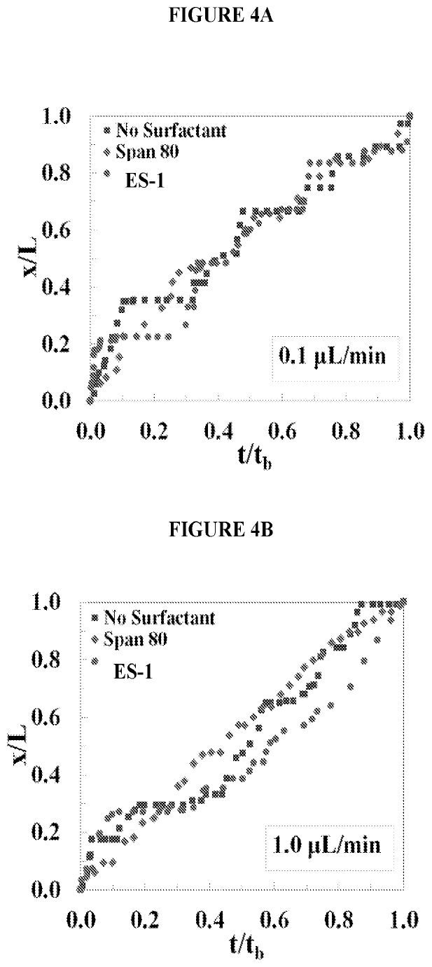

The crude oil flows through the porous media within the duration of t_{b}, which is defined and measured by XCAP™ as the time span from the entry of the crude oil frontier into the screen to the time when it reaches the other end. The initial traveling time to is 0 seconds. Traveling time begins when the frontier of injected crude oil enters the recorded region of the microcapillary and ends when the frontier arrives at the other end of the screen at t=t_{b}. At any arbitrary time, t, the advance distance of the crude oil frontier may be measured. Therefore, advance distance vs. time plot may be obtained. In order to visualize instant drainage flow pattern at different experimental conditions, advance distance and time plot was normalized by the maximum observed length of about 1530 μm through all experiments and the breakthrough time t_{b}, respectively. The plots of FIG. 4A and Figure FB show the results of instant drainage flow pattern for water/crude, water/crude (about 1% Span 80 by weight in the crude), and Water/Crude (about 1% ES-1 by weight in the crude) at about 0.1 μL/min and about 1.0 μL/min.

In comparing the no surfactant (grey) and Span 80 (black) systems, the flow pattern of the former shows a strong stepped-fingering pattern, whereas the oil containing Span 80 exhibits continuous flow. Flow patterns are strongly dependent on the capillary number, Ca, defined as Ca=νμ/γ, where ν is the superficial linear velocity, μ is the viscosity of the more viscous fluid, and γ is the interfacial tension (IFT) between the contacting phases. The density of crude oil is 0.563 g/cm³, the density of water is 0.997 g/cm³, and the respective viscosities are 3.5 mPa·s and 0.89 mPa·s. The values for crude did not change when it contained 1% ES-1 by weight. Table 2 lists the IFT and Ca values for all three systems.

TABLE 2
Interfacial tension and Ca of crude oil
(with and without ES-1)/water systems

| | Interfacial | | |
|---|---|---|---|
| | Tension | Ca | Ca |
| Systems | (mN/m) | 0.1 μL/min | 1.0 μL/min |
| Crude Oil/Water | 51.81 | 7.16 × 10⁻⁶ | 7.98 × 10⁻⁵ |
| Crude Oil (ES-1 1% by | 33.30 | 1.08 × 10⁻⁵ | 1.24 × 10⁻⁴ |
| weight)/Water | | | |
| Crude Oil (Span 80 1% by | 8.27 | 4.64 × 10⁻⁵ | 4.21 × 10⁻⁴ |
| weight)/Water | | | |

The strong fingering pattern exhibited by the crude oil/water system at both flow rates of about 0.1 μL/min and about 1.0 μL/min is due to the high IFT and therefore low Ca. Generally, fingering may be seen when Ca is smaller than or on the order of 10⁻⁴. Such fingering flow occurs because of the domination of capillary forces over viscous forces, and it is known as one of the main reasons for low oil recovery efficiency by water injection flooding methods.

For the solution of crude with about 1% ES-1 by weight, the effect of an increase in Ca due to increased flow rate can be seen in a comparison of the flow patterns for the crude oil/ES-1 solution at the two flow rates. At about 0.1 μL/min, Ca is roughly one order of magnitude lower than Ca at about 1.0 μL/min, and the trend of “stepped” fingering seen at about 0.1 μL/min is attenuated at about 1.0 μL/min. The effect of a decrease in IFT may be observed by comparing the flow patterns of crude at the high flow rate of about 1.0 μL/min in the absence and the presence of ES-1; the “stepped” fingering seen for crude without ES-1 is weakened when ES-1 is present. At the slow flow rate of about 0.1 μL/min, the flow patterns are the same because Ca is low and thus fingering is strong.

The presence of Span 80 lowers the IFT significantly more than the presence of ES-1, resulting in higher corresponding Ca. Based on the drainage flow patterns at various Ca, the flow pattern transitions from continuous to fingering at a critical value of capillary number, Ca_{c}, of between about 7.70×10⁻⁵ and about 4.79×10⁻⁴. When the flow system has a Ca>Caᵣ, the flow pattern is continuous flow, and when the flow system has a Ca<Ca_{c}, the flow pattern is fingering flow. Different systems may have different Ca_{c}. For this crude oil/water system, both flows demonstrate a fingering pattern because Ca_{c} is greater than about 7.98×10⁻⁵. However, in the crude oil/about 1% Span 80 by weight/water system at about Ca=4.64×10⁻⁵, continuous flow still occurred, even at the very low Ca. It means the Ca_{c} of the crude oil/about 1% Span 80 by weight/water system is smaller than that of the crude oil/water system, indicating that the presence of Span 80 in crude oil decreases the Ca_{c}.

When crude is in the invading phase of drainage, capability of Span 80 to lower Ca_{c} and suppress fingering is not a desirable property for the mobilization of crude oil through porous media in either EOR or oil spill cleanup scenarios. Easier penetration of crude into water-filled pores may aid the lodging of crude in areas of the porous medium where it was not found previously. Any surfactant strategy in both EOR and oil spill cleanup must demonstrate the reverse of drainage—an aqueous flooding mixture must displace and mobilize crude oil for the surfactant to be effective.

### Example 5: Instant Imbibition and Delayed Imbibition

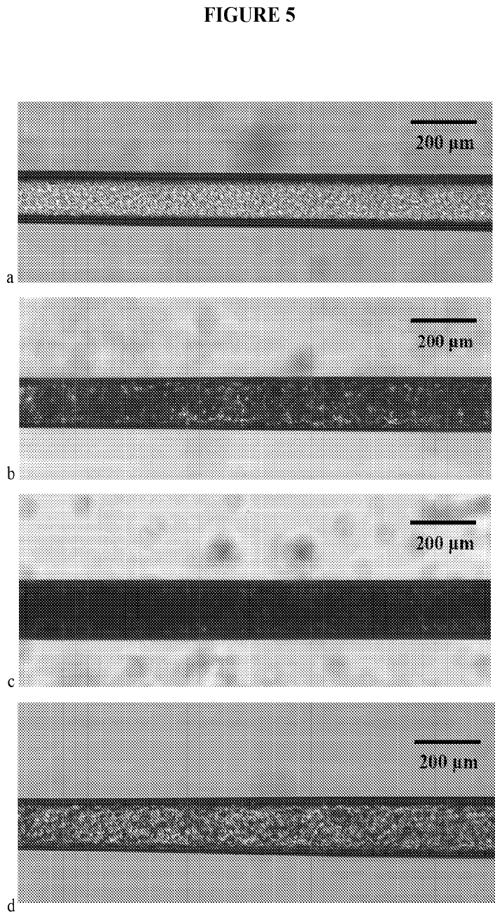

The oil phase is subjected to imbibition or displacement by an invading aqueous phase as it enters and contaminates the water-filled cryolite porous medium under drainage. These experiments used the previously-described systems of water/crude, water/crude (about 1% Span 80 by weight), and water/crude (about 1% ES-1 by weight) at flow rates of about 0.1 pt/min and about 1.0 μL/min. Imbibition videos of the flushing were recorded and images were captured until the image did not change upon more water flow, approximately one minute after flushing was initiated. Image analysis (Image Binarization) was used to quantify the difference in the appearance of the cryolite packed bed from before flushing was initiated to after the flushing was complete. FIG. 5a shows a freshly prepared, water-filled, packed cryolite bed, while the images of the water/crude, water/crude (about 1% Span 80 by weight), and water/crude (about 1% ES by weight) systems after instant imbibition tests at about 1.0 μL/min are shown in FIGS. 5b-5d, respectively.

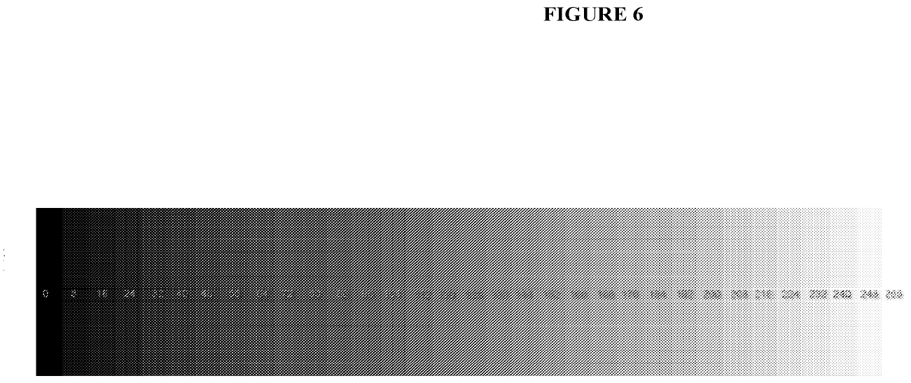

In this disclosure, the effectiveness of cleaning is described by a percentage value that is calculated with Matlab as the percentage of white area of the image of the packed bed region, where 0% is completely black and 100% is completely white. The integrated digital camera is capable of capturing an image in the format of an 8-bit depth grayscale picture. Any arbitrary pixel in this grayscale digital image was saved as a value with the range of 0˜255 to indicate its intensity; FIG. 6 shows this 0˜255 8-bit grayscale stepped pattern. Almost all of the pixels in the captured image have a smaller value than 255, which represents absolute white. This means that for the calculation of cleaning effectiveness, a threshold between 0 and 255 must be used rather than choosing the single value of 255.

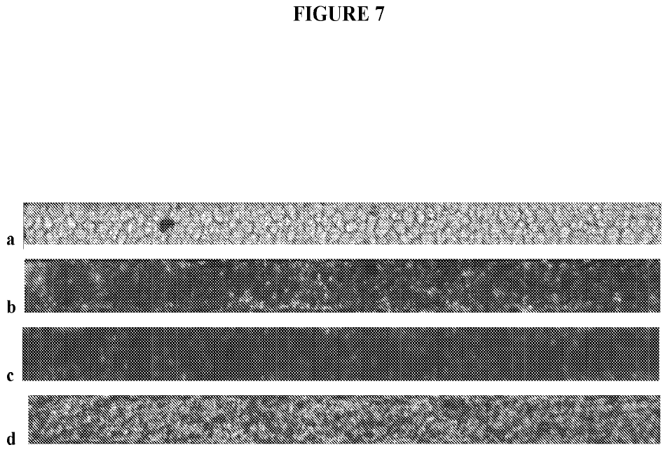

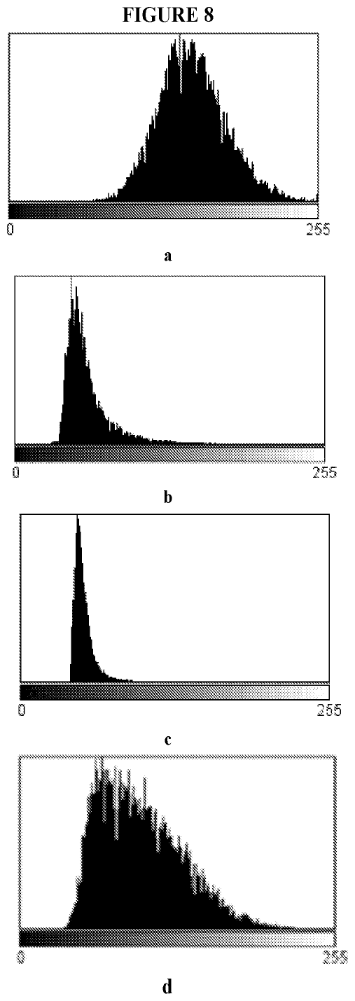

The graphical representation of the intensity distribution in a digital image, known as its histogram, is critical to its binarization. The histogram is plotted as the number of pixels for each intensity value. Before choosing an appropriate algorithm to calculate the threshold, the histogram of the captured grayscale image was obtained via ImageJ software. The grayscale calculation was applied only to the cryolite region; therefore, the original images of FIG. 5 are first cropped into the images shown in FIG. 7. The corresponding image histogram plots obtained via ImageJ are shown in FIG. 8.

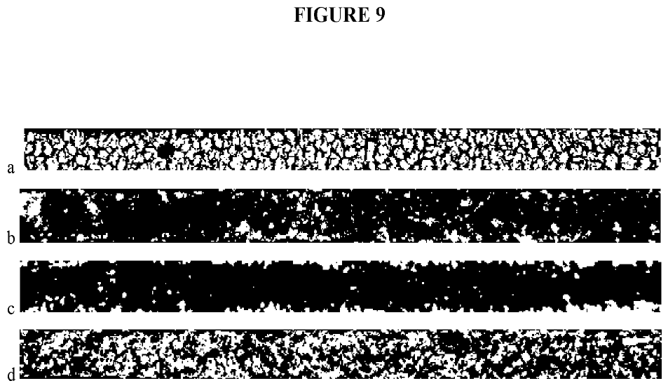

When an image histogram is skewed-shape with a very sharp single peak, such as those seen in FIGS. 8b and 8c, the Triangle algorithm should be used; otherwise, Otsu's method is applied. The Triangle algorithm must be used on relatively smooth histogram plots, so the outliers in the histogram plot were removed before calculation. Otsu's method does not apply in cases with single sharp peak, such as that in FIG. 8c, because the algorithm magnifies the difference between close intensity values within the peak and causes huge errors. The calculated percentage values for FIGS. 8a-8d are 50.54%, 15.09%, 5.76%, and 37.52% respectively, and corresponding converted binary images are shown in FIG. 9.

The percentage of white area calculated from histogram of non-contaminated cryolite packing, shown in FIG. 9a, is 50.54% and, therefore, obtained percentage values from each of the four pictures should range from 0% (completely contaminated) to 50.54% (completely clean). For the purpose of easier comparisons, all calculated percentage values are re-scaled linearly from 0% to 50.54% to 0% to 100%. The values on the 0˜100 scale indicate the effectiveness of each system in cleaning the crude oil from the cryolite. The cleaning results were analyzed at both instant and delayed conditions, and are summarized for both about 0.1 μL/min and 1.0 μL/min flow rates in Table 3.

TABLE 3
Results summary of cleaning effectiveness as white pixel percentage
of crude oil (with and without surfactant)/water systems.

| | Instant | | Delayed | |
|---|---|---|---|---|
| | Imbibition | | Imbibition | |
| Systems | 0.1 μL/min | 1.0 μL/min | 0.1 μL/min | 1.0 μL |
| Crude Oil/Water | 34.51 | 29.86 | 26.79 | 23.03 |
| (Crude Oil + Span | 5.06 | 11.40 | 4.23 | 4.19 |
| 80 1% b.w.)/Water | | | | |
| (Crude Oil + | 35.12 | 74.24 | 48.98 | 79.30 |
| ES-1 1% | | | | |
| b.w.)/Water | | | | |
| (Crude oil + | 15.97 | 60.80 | 17.53 | 45.69 |
| ES-2 1% | | | | |
| b.w.)/water | | | | |
| (Crude oil + | 52.05 | 48.37 | 14.73 | 42.80 |
| ES-3 1% | | | | |
| b.w)/water | | | | |

The results shown in Table 3 demonstrate that the systems comprising crude oil with PIBSI 1% by weight have the best performance with significantly enhanced cleaning compared to the systems of crude oil without surfactant and crude oil with 1% Span 80 by weight. The data comparing instant imbibition to delayed imbibition show that immersion for five days did not noticeably affect cleaning effectiveness. Flushing performance is directly related to the wettability of the cryolite surface by the oil phase. When clean, the cryolite is more strongly wetted by water than crude oil.

Different cleaning efficiencies are obtained by changing the chemical characteristics of the PIBSA-based surfactant. In table 3 the white pixel percentage are shown, of two systems obtained with the same crude oil as before, but added with the PIBSI derivatives ES-2 and ES-3 obtained as described in previous Examples 2 and 3.

It's evident that results depend on the chemical composition of the additive and that a range of molecules can be individuated to promote the mobility of the crude oil adsorbed onto the solid porous phase with efficiencies generally higher than those of the crude oil alone and of the Span 80 surfactant.

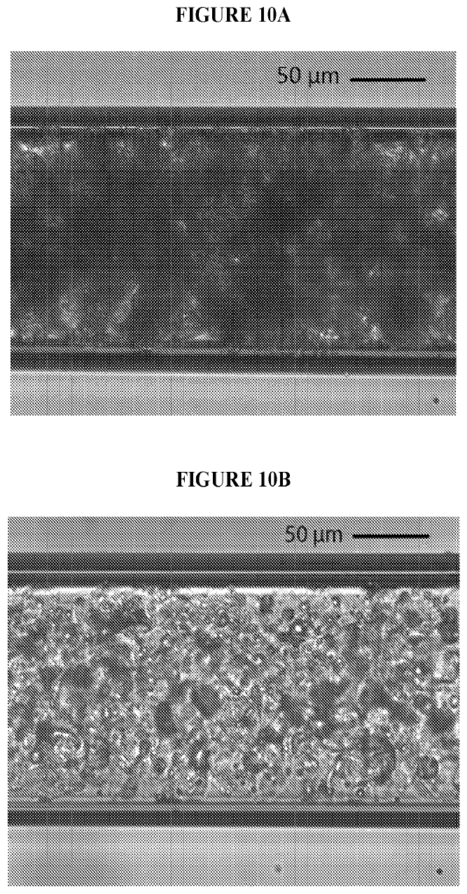

To further explore the phenomenon of wettability, the images for the crude oil (Span 80 1% by weight)/water and crude oil (ES-1 1% by weight)/water systems are shown in FIGS. 10A and 10B at 20× magnification. In the system with PIBSI (FIG. 10A), the remaining crude oil trapped in the interstices formed by cryolite particles was in the form of tiny droplets. On the contrary, in the Span 80 system (FIG. 10B), much of the remaining crude oil was spread on the cryolite surface, demonstrating that the presence of Span 80 induces oil wetting of the cryolite. Therefore, the tested systems with PIBSI decreased the wettability of cryolite, leading to the superior effectiveness of those systems.

Flushing the crude oil (ES-1% by weight)/water system at about 1.0 μL/min produced much better cleaning results than flushing at about 0.1 μL/min. This result is in agreement with a low crude oil wettability of the cryolite and with the oil drops trapped in the pores instead of spread over the cryolite. The higher flow rate led to a stronger water flush, resulting in easier cleaning of the trapped drops.

When crude oil wetted the cryolite, as in the absence of surfactant, the crude oil attached on the cryolite, and the faster flow rate did not improve the cleaning. This is consistent with previous observations that increased injection rate leads to reduced EOR rate. Higher flooding rates enhance the differential pressure within pores, leading to the rapid breakdown of the oil bank by an invading water phase and resulting in early water breakthrough. Once the aqueous phase breaks through, the crude oil left behind cannot easily be recovered by flushing.

Traditionally, lowering IFT has been the focus of enhancing oil recovery efficiency by reducing capillary forces. As seen in Table 2, the presence of PIBSI in crude oil at 1% by weight decreases the IFT by approximately half, although it by no means produces an ultralow IFT. The data disclosed herein demonstrate that EOR and oil spill cleanup schemes with moderate IFT reduction may be effective in mobilizing oil. Although the 1% Span 80 by weight system had the lowest IFT, it also had the lowest cleaning effectiveness due to its negative effect on the wetting behavior between the oil phase and the cryolite surface.

IFT is not the only parameter that determines the detachment phenomena of the oil phase from the solid surface and thus impacts the improvement of overall recovery rate. As explained above, wettability plays a major role in the cleanup process with oil-soluble surfactant. Lowering a porous medium's wettability by crude oil may significantly contribute to the accumulation of displaced oil and early formation of oil-banks, and formation of mobile oil banks is a very important step in crude oil recovery processes. Promoting earlier formation of mobile oil banks may indicate improved cleaning effectiveness and oil recovery.

### Micellar-Enhanced Instant Imbibition and Delayed Imbibition

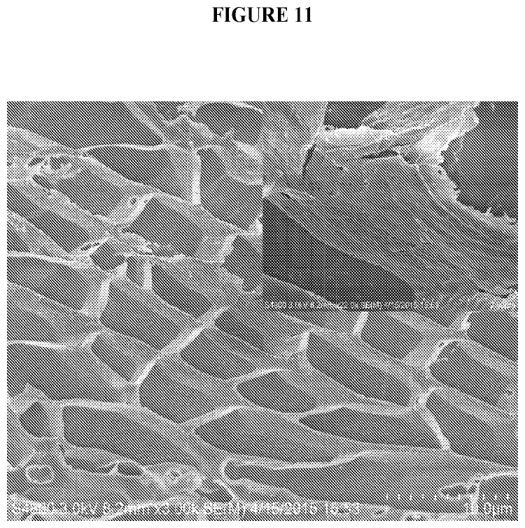

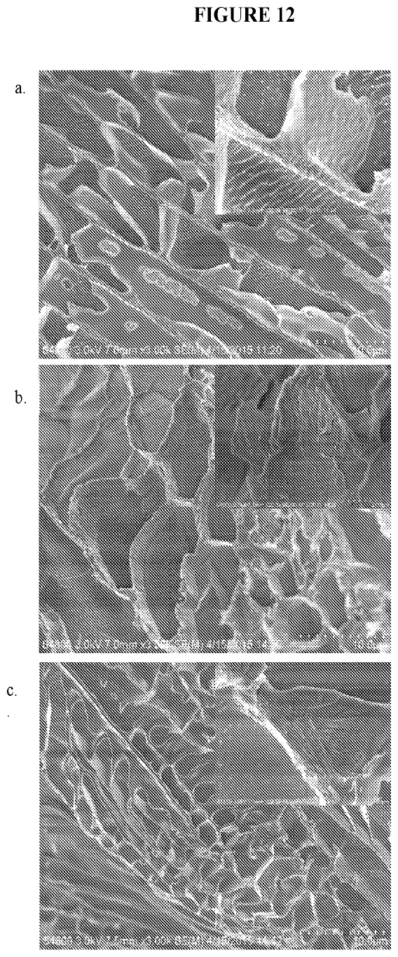

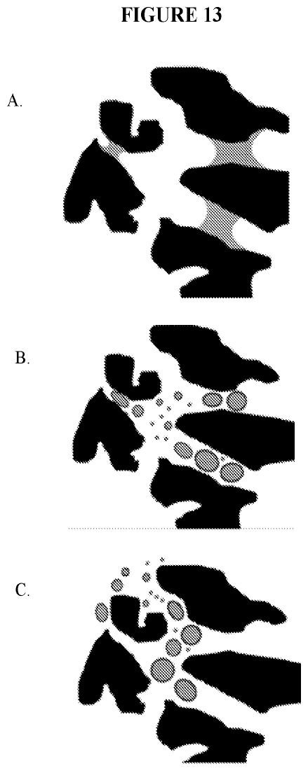

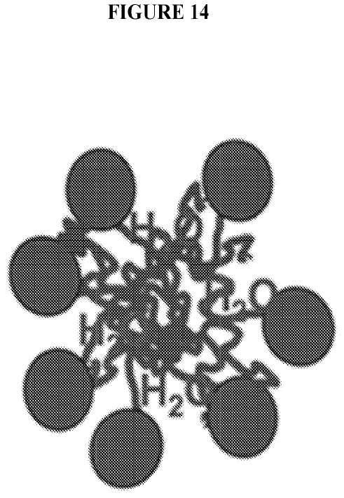

In oilfield EOR as well as oil-spill cleanup operations, an oil-soluble surfactant must be delivered to the oil-water and liquid-solid interfaces by a flooding aqueous solution. Here, SDS micelles are used as a vehicle to deliver the oil-soluble surfactant to the crude oil in order to promote its mobilization and flow out of the porous media. The flooding mixtures were prepared as described above and were characterized via Cryo-SEM. FIG. 11 shows Cryo-SEM images of pure SDS solution. The “honey comb” structure visible at low magnification was self-assembled and formed by the SDS surfactant present in the solution due to crystallization during the freezing process of specimen preparation. Fracturing of the frozen specimen creates a newly exposed smooth surface that is then subjected to sublimation, resulting in a much lower water presence. Images for three SDS/ES-1 solutions are shown in FIG. 12 at both low and high magnification.

At low magnification, all the images in FIG. 12 showed a network structure, similar to that of FIG. 11 to various extents. At low concentrations of PIBSI, the distinction between the features of FIG. 11 and FIG. 12a is not significant even at high magnification. However, a solution with the concentration of ES-1 increased up to 500:1 reveals rod-like structures within the SDS, shown in FIG. 12b. These rod-like structures are SDS micelles that carry the polymeric ES-1. These micellar rod-like structures are highly visible in all of the SDS Cryo-SEM features for the 100:1 SDS/ES-1 ratio show in FIG. 12c.

The three SDS/ES micellar compositions were used for both instant and delayed imbibition tests at flow rates of about 0.1 μL/min and about 1.0 μL/min to test their performance in crude oil cleanup and EOR. Here, the aqueous flooding phase is an SDS/ES solution acting on crude oil that does not contain any surfactant. The cleaning processes were carried out for solutions of SDS only and SDS:ES-1 solutions at ratios of 1000:1, 500:1, and 100:1 with each condition repeated four times for reproducibility. Table 4 shows a summary of the results; each white pixel percentage value is the average of four repeats.

TABLE 4
Cleaning effectiveness as white pixel percentage
for SDS:ES-1 micelles solutions

| | Instant | | Delayed | |
|---|---|---|---|---|
| | Imbibition | | Imbibition | |
| Systems | 0.1 μL/min | 1.0 μL/min | 0.1 μL/min | 1.0 μL/min |
| SDS only | 36.76 | 31.83 | 29.99 | 29.73 |
| solution | | | | |
| SDS:ES-1 | 24.32 | 25.48 | 17.79 | 18.93 |
| 1000:1 | | | | |
| SDS:ES-1 | 29.55 | 25.68 | 20.76 | 23.52 |
| 500:1 | | | | |
| SDS:ES-1 | 51.86 | 64.76 | 40.82 | 67.15 |
| 100:1 | | | | |

The SDS:ES-1 solutions with ratios of 1000:1 and 500:1 did not clean the packed-bed well for tests at either about 0.1 μL/min or about 1.0 μL/min. Notably, their cleaning efficiencies are even slightly poorer than those of the 0.4 M SDS only solution.

The SDS:ES-1 solution at the 100:1 ratio produced remarkable cleaning efficiency, and flushing at about 1.0 μL/min showed better cleaning results than flushing at about 0.1 μL/min for both instant and delayed imbibition. This cleaning behavior is similar to that of the crude oil containing 1% ES-1 by weight system, as described above. In both successful instances, mobile crude oil droplets were formed in the pores of the medium and were flushed more easily by a stronger flow. Taken together, these results shows that ES-1 contributed to reducing the wettability of cryolite by crude oil and that the aqueous flooding mixture delivered ES-1 to the interface via SDS micelles, allowing ES-1 to function in the same way as when it was introduced directly to the crude oil phase by injection.

IFT values for the SDS/ES-1 aqueous solutions were found to be much lower due to the presence of SDS. The flooding mixture with the highest concentration of ES-1 corresponded to the lowest IFT value, as shown in Table 5.

TABLE 5
Interfacial tension of Crude Oil/Micellar Solution systems

| | Interfacial Tension |
|---|---|
| Systems | mN/m |
| SDS only Solution (0.4M) | 1.45 |
| SDS:ES-1 1000:1 | 1.52 |
| SDS:ES-1 500:1 | 1.06 |
| SDS:ES-1 100:1 | 0.93 |

The data presented herein demonstrate that EOR and oil spill cleanup may be achieved using oil-soluble surfactant. Direct addition of PIBSI into the crude oil phase was effective in mobilizing crude oil through the porous media by reducing both interfacial tension and the wettability of crude oil on cryolite. The cleaning efficiency of PIBSI was compared to the behavior of a commonly known oil-soluble surfactant, Span 80, which proved to be detrimental to crude-oil mobilization. However, Span 80 yielded the lowest interfacial tension, indicating that a low IFT is not a determining condition for crude oil mobilization in porous media. The oil-soluble PIBSI was effectively delivered via micelles of a hydrosoluble surfactant to successfully mobilize crude oil trapped in porous media. Cryo-SEM images revealed the presence of rod-like SDS/ES-1 micelles, which were the vehicles that transported the PIBSI to the crude oil's interface with the flooding mixture. The interfacial tension of the resulting oil-water interface was lowered significantly by the presence of SDS and ES-1, and the latter was found to reduce the wettability of the porous medium (cryolite) by crude oil. SDS/PIBSI micelles have broad applications as oil spill dispersants or, more broadly, for flushing non-polar contaminants from porous media. Other applications may include drug delivery and catalysis; encapsulation or flushing of contaminants, toxins, drugs, and or catalysts; and as emulsifiers, surfactants, detergents, surface modifiers, and nanocomposite fillers, as well as other biomedical, research, consumer, or industrial applications.

1. A micellar composition comprising:
an oil-soluble surfactant and
a water-soluble surfactant;
wherein said oil-soluble surfactant is solubilized in said water-soluble surfactant.

2. The micellar composition of claim 1, wherein said oil-soluble surfactant comprises a polyisobutenyl anhydride derived surfactant.

3. The micellar composition of claim 1, wherein said water-soluble surfactant comprises sodium dodecyl sulfate.

4. The micellar composition of claim 1, wherein said water-soluble surfactant is in an aqueous solution.

5. The micellar composition of claim 1, further comprising a solubilizing compound.

6. The micellar composition of claim 5, wherein said water-soluble surfactant is present in a predetermined amount comprised between the minimum critical micellar concentration and the saturation concentration in the solubilizing compound.

7. The micellar composition of claim 6, wherein the predetermined amount of said water-soluble surfactant is comprised between 0.3 and 0.9 times the saturation concentration.

8. The micellar composition of claim 1, wherein said oil-soluble surfactant and said water-soluble surfactant in said aqueous solution are present in a weight ratio of about 1:10 to about 1:10000.

9. The micellar composition of claim 8, wherein said weight ratio is selected from the group comprising: about 1:100, about 1:500, and about 1:1000.

10. A method for removing one or more non-polar contaminants or substance from porous media comprising the steps of:
a. providing a micellar composition comprising an oil-soluble surfactant and a water-soluble surfactant wherein said oil-soluble surfactant is solubilized in said water-soluble surfactant; and
b. applying said micellar composition to a porous medium containing a non-polar contaminant or substance.

11. The method of claim 10, further comprising the step of wetting said porous medium containing said non-polar contaminant or substance before applying said micellar composition.

12. The method of claim 10, further comprising the step of flushing said porous medium containing said non-polar contaminant or substance after applying said micellar composition.

13. The method of claim 10, wherein the composition further comprises at least one solubilizing compound.

14. The method of claim 10, wherein said oil-soluble surfactant comprises a polyisobutenyl anhydride derived composition.

15. The method of claim 10, wherein said water-soluble surfactant comprises sodium dodecyl sulfate.

16. The method of claim 10, wherein said water-soluble surfactant is in an aqueous solution.

17. The method of claim 13, wherein said water-soluble surfactant is in a predetermined amount comprised from the minimum critical micellar concentration and the saturation concentration in the solubilizing compound.

18. The method of claim 17, wherein the predetermined amount of said water-soluble surfactant is comprised between 0.3 and 0.9 times the saturation concentration.

19. The method of claim 10, wherein said oil-soluble surfactant and said water-soluble surfactant are present in a ratio of about 1:10 to about 1:10000.

20. The method of claim 10, wherein the ratio is selected from the group comprising about 1:100, about 1:500, and about 1:1000.

21. The method of claim 10, wherein the one or more non-polar contaminants or substances are selected from the group comprising: petroleum, toxins, pharmaceutical compositions, catalysts, or any other appropriate non-polar contaminants.

22. The method of claim 10, wherein the at least one porous medium is selected from the group comprising: sand, water-body sediment, soil, wood, rock, or any other appropriate porous medium.

23. A method for extracting oil from porous media comprising the steps of:
providing a micellar composition comprising an oil-soluble surfactant and a water-soluble surfactant according to claim 1;
applying said micellar composition to a porous media; and
capturing any resulting oil from said porous media.

24. The method of claim 23, further comprising the step of: wetting said porous media before applying said micellar composition.

25. The method of claim 23, further comprising the step of: flushing said porous media after applying said micellar composition.

26. The method of claim 23, wherein said water-soluble surfactant is in an aqueous solution.

27. The method of claim 23, wherein said oil-soluble surfactant comprises a polyisobutenyl anhydride derived composition.

28. The method of claim 23, wherein said water-soluble surfactant comprises sodium dodecyl sulfate.

29. The method of claim 23, wherein said oil-soluble surfactant and said water-soluble surfactant are present in a ratio of about 1:10 to about 1:10000.

30. The method of claim 23, wherein the one or more porous media are selected from the group comprising: oil shale, porous rock formations, sand, water-body sediment, soil, wood, rock, or any other appropriate porous medium.
